(19) United States
(12) Patent Application Publication
(10) Pub. No.: US 2015/0199767 A1
(43) Pub. Date: Jul. 16, 2015

(54) System for Consolidating Customer Transaction Data

(71) Applicant: Bank of America Corporation, Charlotte, NC (US)

(72) Inventors: Subramanian Selvaraj Sulur, Charlotte, NC (US); Wan Lung Alvin Lee, Charlotte, NC (US); Alpesh Rajnikant Shah, Marvin, NC (US); Carl Suplee, Huntersville, NC (US)

(73) Assignee: Bank of America Corporation, Charlotte, NC (US)

(21) Appl. No.: 14/155,919

(22) Filed: Jan. 15, 2014

(51) Int. Cl. G06Q 40/00

(52) U.S. Cl. CPC G06Q 40/12

(57) ABSTRACT

According to one embodiment, a system receives a plurality of system records corresponding to one of a plurality of financial transactions. The system determines a subset of system records comprising a posting record, a channel record, and an instrument record that correspond to a selected transaction of the plurality of financial transactions. The posting record comprises one or more posting attributes indicating a change in an account balance that a first source associates with the selected transaction. The channel record comprises one or more channel attributes indicating how a customer interfaced with a financial institution that a second source associates with the selected transaction. The instrument record comprises one or more instrument attributes indicating an exchange medium. The posting record, channel record, and instrument record are consolidated and linked to yield a transaction record. The system stores the transaction record in a transaction database. The system communicates the transaction record.

### TECHNICAL FIELD

The present invention relates generally to financial services and more specifically to a system and method for consolidating customer transaction data.

### BACKGROUND

Banks, financial institutions, and other businesses use customer transaction data for monitoring, marketing, or other similar purposes. Currently, the transaction data is stored in various formats across multiple systems. Storing the transaction data in multiple systems often results in data redundancies and inconsistencies, and often requires writing a great deal of custom code to source and merge transaction data for analytics and automated monitoring. In addition, accessing the transaction data from multiple sources may require using a combination of custom and ad-hoc lookup mechanisms that may be inconsistent from one source to the next.

### SUMMARY OF EXAMPLE EMBODIMENTS

In accordance with the present invention, disadvantages and problems associated with accessing customer transaction data may be reduced or eliminated.

According to one embodiment of the present invention, a system receives a plurality of system records corresponding to one of a plurality of financial transactions. The system determines a subset of system records comprising a posting record, a channel record, and an instrument record that correspond to a selected transaction of the plurality of financial transactions. The posting record comprises one or more posting attributes indicating a change in an account balance that a first source associates with the selected transaction. The channel record comprises one or more channel attributes indicating how a customer interfaced with a financial institution that a second source associates with the selected transaction. The instrument record comprises one or more instrument attributes indicating an exchange medium. The posting record, channel record, and instrument record are consolidated and linked to yield a transaction record. The system stores the transaction record in a transaction database. The system communicates the transaction record.

Certain embodiments of the invention may provide one or more technical advantages. A technical advantage of one embodiment includes consolidating and linking customer transaction data from multiple sources into a centralized transaction data repository for monitoring, marketing, or other similar purposes. Providing a consolidated view of transaction data in a standard presentation layer removes data redundancies and inconsistencies, and reduces the cost and complexity of monitoring customer transactions for suspicious activities. Another technical advantage of an embodiment includes communicating a risk indicator associated with the transaction data if the transaction data presents a risk.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system that consolidates and links customer transaction data from multiple sources;

FIG. 2A illustrates an example of a posting record corresponding to a financial transaction;

FIG. 2B illustrates an example of a channel record corresponding to the financial transaction;

FIG. 2C illustrates an example of an instrument record corresponding to the financial transaction;

FIG. 2D illustrates an example of a transaction record stored in a database of server memory;

FIG. 3 illustrates a flowchart for consolidating customer transaction data and communicating the consolidated data to users; and

FIG. 4 illustrates a block diagram of an example system that consolidates and links customer transaction data from multiple sources.

### DETAILED DESCRIPTION

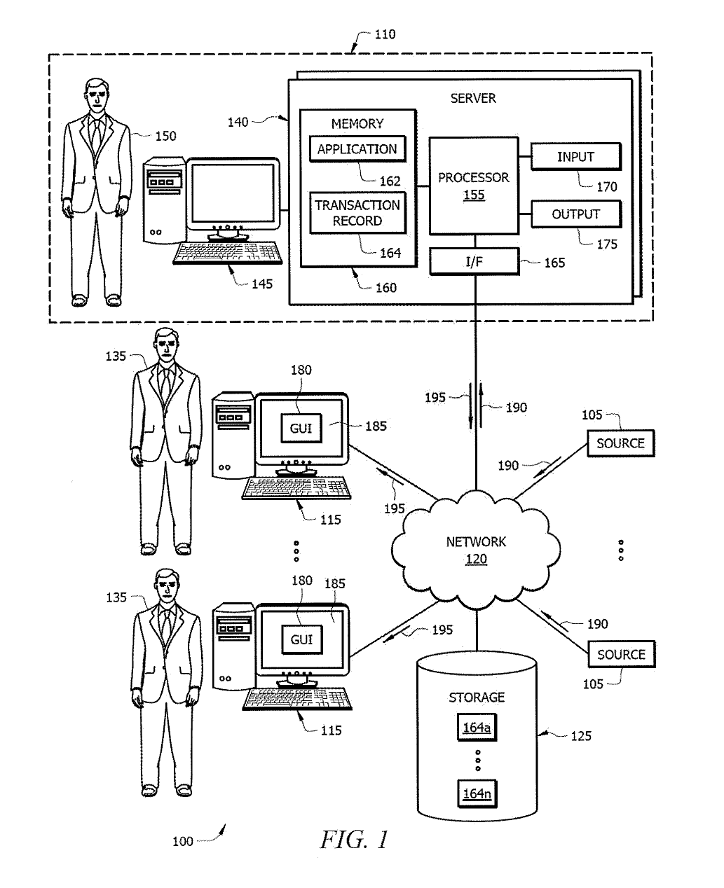

Embodiments of the present invention and its advantages are best understood by referring to FIGS. 1 through 3 of the drawings, like numerals being used for like and corresponding parts of the various drawings.

Banks, financial institutions, and other businesses use customer transaction data for monitoring, marketing, or other similar purposes. Currently, the transaction data is stored in various formats across multiple systems. Storing the transaction data in multiple systems often results in data redundancies and inconsistencies, and often requires writing a great deal of custom code to source and merge transaction data for analytics and automated monitoring. In addition, accessing the transaction data from multiple sources may require using a combination of custom and ad-hoc lookup mechanisms that may be inconsistent from one source to the next. The teachings of this disclosure recognize that it would be desirable to consolidate and link customer transaction data from multiple sources into a centralized transaction data repository for users. FIGS. 1 through 3 below illustrate a system and method of consolidating transaction data into a transaction record and communicating the transaction record in a standard presentation layer.

FIG. 1 illustrates a system 100 according to certain embodiments. System 100 may include one or more sources 105, an enterprise 110, one or more clients 115, a network storage device 125, one or more users 135, and one or more servers 140. Sources 105, enterprise 110, clients 115, and network storage device 125 may be communicatively coupled by a network 120. Enterprise 110 is generally operable to provide a complete transaction record 164, as described below.

In general, one or more servers 140 may receive system records 190 for a plurality of transactions, determine a subset of system records 190 that correspond to the same transaction, and consolidate and link the subset of system records 190 into a transaction record 164. Examples of system records 190 include posting records 190a, channel records 190b, and/or instrument records 190c. Posting records 190a indicate movement of money to or from an account, channel records 190b indicate how a customer interfaced with a financial institution, and instrument records 190c indicate an exchange medium used in the transaction. As an example, server(s) 140 may consolidate posting record 190a(1) (e.g., the customer withdrew $100), channel record 190b(1) (e.g., the withdrawal occurred at an ATM located at a particular address), and instrument record 190c(1) (e.g., five $20 bills were dispensed) into transaction record 164 upon a determination that records 190a(1), 190b(1), and 190c(1) correspond to the same transaction.

In some embodiments, server 140 receives system records 190 from sources 105. A source 105 may refer to any system, process, or tool that generates and communicates system record 190 to server 140. It will be understood that system 100 may comprise any number and combination of sources 105. In some embodiments, server 140 may receive system records 190 comprising a plurality of posting records 190a from a first source 105a, a plurality of channel records 190b from a second source 105b, and a plurality of instrument records 190c from a third source 105c. Server 140 may process system records 190 from the various sources 105a-c to determine the subset of system records 190 that correspond to a selected transaction. The selected transaction may be a deposit, withdrawal, transfer, wire, payment, loan, purchase, mortgage, credit, or other financial transaction that a particular department, line of business, or other group within enterprise 110 associates with a customer. The selected transaction may be associated with the customer's personal accounts and/or business accounts.

In general, server 140 determines a subset of system records 190 that correspond to the selected transaction and connects the subset of system records 190 to yield a complete transaction record 164. Server 140 may analyze one or more reference attributes of a particular system record 190 to determine whether the particular system record 190 corresponds to the selected transaction. Examples of reference attributes that server 140 can use to correlate a system record 190 to the selected transaction include a card number, customer name, customer identifier, transaction type, date, account number, account type, product, location, transaction amount, and/or transaction sequence number.

In some embodiments, server 140 may determine that two system records 190 correspond to the selected transaction by matching one or more reference attributes of a first system record 190 to one or more reference attributes of a second system record 190. As an example, if a posting record 190a(1) comprises a card number and an account number, and a channel record 190b(1) comprises a customer name and the same account number, server 140 may link posting record 190a(1) and channel record 190b(1) to the selected transaction using the matching account numbers.

In the illustrated embodiment, server 140 consolidates and links the subset of system records 190 that correspond to the selected transaction to yield transaction record 164. Transaction record 164 may be stored in one or more related files in one or more databases and may comprise any data associated with the selected transaction. For example, transaction record 164 can include data that identifies the selected transaction, such as a unique transaction identifier or a combination of reference attributes unique to the selected transaction (e.g., an account number in combination with a transaction sequence number and date, or any other suitable combination of reference attributes). As another example, customer transaction data can include data indicating a change in account balance resulting from the selected transaction, how a customer interfaced with a financial institution to perform the selected transaction, and/or an exchange medium used in the selected transaction. In some embodiments, transaction record 164 can also include data associated with the account and/or customer that transacted the selected transaction, such as whether the account corresponds to a personal account or business account, contact information (e.g., email address, phone number, street address), related account information (e.g., other accounts owned by the same customer or members of the customer's household), risk status (e.g., whether the customer has recently conducted any suspicious transactions), and/or other data.

Server 140 may communicate transaction record 164 to user 135 utilizing client 115. Client 115 may refer to any device that enables user 135 to interact with server 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface such as a display 185, microphone, keyboard, or any other appropriate terminal equipment usable by user 135. It will be understood that system 100 may comprise any number and combination of clients 115 or users 135.

User 135 may utilize client 115 to interact with server 140 to receive transaction record 164 via alert 195. In some embodiments, user 135 may be a financial institution employee conducting an investigative analysis of one or more financial transactions. In some embodiments, server 140 may communicate alert 195 in response to a request from user 135. As examples, user 135 may request transaction records 164 associated with a particular customer, transaction records 164 associated with a particular time period, and/or transaction records 164 associated with potentially suspicious activity (e.g., based on monetary amount, location, transaction frequency, risk level, and/or other criteria). In some embodiments, server 140 may communicate alert 195 in response to pre-configured criteria and independently of a request from user 135. As an example, the pre-configured criteria may cause server 140 to communicate alert 195 if a risk-determination rule indicates that a risk level associated with transaction record 164 exceeds a pre-determined risk threshold.

In some embodiments, client 115 may include a graphical user interface (GUI) 180. GUI 180 is generally operable to tailor and filter data presented to user 135. GUI 180 may provide user 135 with an efficient and user-friendly presentation of transaction record 164. GUI 180 may comprise a plurality of displays having interactive fields, pull-down lists, and buttons operated by user 135. GUI 180 may include multiple levels of abstraction including groupings and boundaries. It should be understood that the term GUI 180 may be used in the singular or in the plural to describe one or more GUIs 180 and each of the displays of a particular GUI 180.

In the illustrated embodiment, network storage device 125 stores transaction records 164a through 164n. Network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), removable storage media (for example, a Compact Disk (CD) or a Digital Video Disk (DVD)), database and/or network storage (for example, a server), and/or any other volatile or non-volatile, non-transitory computer-readable memory devices that store one or more files, lists, tables, or other arrangements of information. Network storage device 125 may store any data and/or instructions utilized by server 140.

Sources 105, clients 115, servers 140, and other components of system 100 may be communicatively coupled by network 120. In certain embodiments, network 120 may refer to any interconnecting system capable of transmitting audio, video, signals, data, messages or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 140, an administrator workstation 145, and an administrator 150. In some embodiments, server 140 may refer to any suitable combination of hardware and/or software implemented in one or more modules to process data and provide the described functions and operations. In some embodiments, the functions and operations described herein may be performed by a pool of servers 140. In some embodiments, server 140 may include, for example, a mainframe, server, host computer, workstation, web server, file server, a personal computer such as a laptop, or any other suitable device operable to process data. In some embodiments, server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 140 consolidates and links system records 190 corresponding to the selected transaction to yield transaction record 164 and communicates transaction record 164 to users 135 via alert 195. In some embodiments, server 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, RAM or ROM), mass storage media (for example, a hard disk), removable storage media (for example, a CD or a DVD), database and/or network storage (for example, a server), and/or any other volatile or non-volatile, non-transitory computer-readable memory devices that store one or more files, lists, tables, or other arrangements of information. Although FIG. 1 illustrates server memory 160 as internal to server 140, it should be understood that server memory 160 may be internal or external to server 140, depending on particular implementations. Also, server memory 160 may be separate from or integral to other memory devices to achieve any suitable arrangement of memory devices for use in system 100.

Server memory 160 is generally operable to store an application 162 and transaction record 164. Application 162 generally refers to logic, rules, algorithms, code, tables, and/or other suitable instructions for performing the described functions and operations. In some embodiments, application 162 facilitates generating transaction records 164 from system records 190 and communicating transaction records 164 to users 135 via alerts 195.

Server memory 160 communicatively couples to processor 155. Processor 155 is generally operable to execute application 162 stored in server memory 160 to generate and communicate transaction record 164 according to the disclosure. Processor 155 may comprise any suitable combination of hardware and software implemented in one or more modules to execute instructions and manipulate data to perform the described functions for servers 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 140, send output from server 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or another communication system, which allows server 140 to communicate to other devices. Communication interface 165 may include any suitable software operable to access data from various devices such as clients 115 and/or network storage device 125. Communication interface 165 may also include any suitable software operable to transmit data to various devices such as clients 115 and/or network storage device 125. Communication interface 165 may include one or more ports, conversion software, or both. In general, communication interface 165 receives system records 190 from sources 105 and transmits transaction record 164 via alert 195 to client 115.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 140 using an administrator workstation 145. In some embodiments, administrator workstation 145 may be communicatively coupled to server 140 and may refer to any suitable computing system, workstation, personal computer such as a laptop, or any other device operable to process data. In certain embodiments, administrator 150 may utilize administrator workstation 145 to manage server 140 and any of the data stored in server memory 160 and/or network storage device 125.

In operation, application 162, upon execution by processor 155, facilitates connecting system records 190 to yield transaction record 164 and communicating transaction record 164 to users 135 via alert 195. To provide transaction record 164, application 162 may first receive a plurality of system records 190 corresponding to a plurality of financial transactions from sources 105. For example, application 162 may receive a plurality of posting records 190a from a first source 105a, a plurality of channel records 190b from a second source 105b, and a plurality of instrument records 190c from a third source 105c. In some alternative embodiments, application 162 may receive one or more of the plurality of channel records 190b and/or one or more of the plurality of instrument records 190c from two or more sources 105. For example, application 162 may receive both channel record 190b and instrument record 190c from the second source 105b. As another example, application 162 may receive channel record 190b and instrument record 190c from both second source 105b and third source 105c.

Application 162 may then determine a subset of system records 190 that correspond to a selected one of the transactions, such as transaction number 1, and link the subset of system records 190 together. As an example, application 162 may determine that posting record 190a(1), channel record 190b(1), and instrument record 190c(1) correspond to the selected transaction and therefore belong in the subset. In some embodiments, posting record 190a(1), channel record 190b(1), and instrument record 190c(1) may each include one or more reference attributes that can be used to link the records to each other and/or to the selected transaction. Examples of reference attributes include card number, customer name, customer identifier, transaction type, date, account number, account type, product, location, transaction amount, transaction sequence number, and so on.

After determining that posting record 190a(1), channel record 190b(1), and instrument record 190c(1) correspond to the selected transaction, application 162 may consolidate and link one or more attributes of these records to yield transaction record 164. Examples of attributes include reference attributes, posting attributes that indicate a change in an account balance resulting from the selected transaction (e.g., an account starting balance, account ending balance, account record, account number, and/or date of transaction), channel attributes that indicate how a customer interfaced with the financial institution to perform the selected transaction (e.g., data describing an ATM, banking center, wire transfer portal, or online banking application that the customer interfaced with to perform the selected transaction), and instrument attributes that indicate an exchange medium used in the selected transaction (e.g., cash, wire, check, account transfer, ATM deposit, or ATM withdrawal). Consolidating and linking attributes can include adding attributes to transaction record 164, removing duplicate attributes included in transaction record 164, and/or reconciling inconsistencies in transaction record 164 (e.g., if different sources list attributes in different formats, consolidate the attribute that fits a target format). In certain embodiments, transaction record 164 may be stored in a transaction database of server memory 160.

After yielding transaction record 164, application 162 may generate a unique transaction identifier and associate the transaction identifier with transaction record 164. The transaction identifier may refer to a unique identifier assigned by the financial institution to identify system records 190 that correspond to the selected transaction. For example, the transaction identifier may be used to identify the posting record 190a, channel record 190b, and instrument record 190c associated with the selected transaction and consolidated into transaction record 164.

Application 162 communicates transaction record 164 in any suitable format. In some embodiments, application 162 communicates transaction record 164 via alert 195. Alert 195 may comprise one or more transaction records 164 associated with the customer and/or one or more risk indicators (e.g., based on suspicious activity, financial crimes, corruption, and/or economic sanctions compliance information) associated with one or more transaction records 164. In certain embodiments, alert 195 can have a standardized format comprising standardized fields. Moreover, alert 195 may be communicated to a display or other user interface, or it can be communicated to a downstream processor. For example, one or more servers 140 may provide alert 195 to user 135 by utilizing client 115. In some embodiments, user 135 may utilize client 115 to receive alert 195. For example, application 162 may communicate alert 195 in response to user 135 requesting one or more transaction records 164 associated with the customer.

In some embodiments, application 162 may communicate a risk indicator associated with transaction record 164 to user 135 if transaction record 164 presents a risk. For example, application 162 may process transaction record 164 according to a risk-determination rule to determine a risk level. If the risk level exceeds a pre-determined threshold, the risk indicator may be communicated. An example of a risk-determination rule may be to determine whether transaction record 164 indicates that the selected transaction is associated with potentially suspicious activity based on dollar amount, location, relationship to other potentially suspicious transactions, or other criteria. Examples of potentially suspicious activity may include cash structuring, large cash deposits, high-amount transactions or fund transfers inconsistent with the customer's transaction history or income, multiple wires to multiple people on the same day with corresponding dollar amounts, and so on. Any suitable risk indicator may be used. For example, the data that caused the risk to be generated may be highlighted or a text description of the risk may be provided. In some embodiments, application 162 may communicate a risk score, such as a scored based on a formula that includes transaction record 164 as an input, that may be used by user 135 to evaluate the risk. The score may be calculated at a line of business level, an enterprise level, and/or other suitable level.

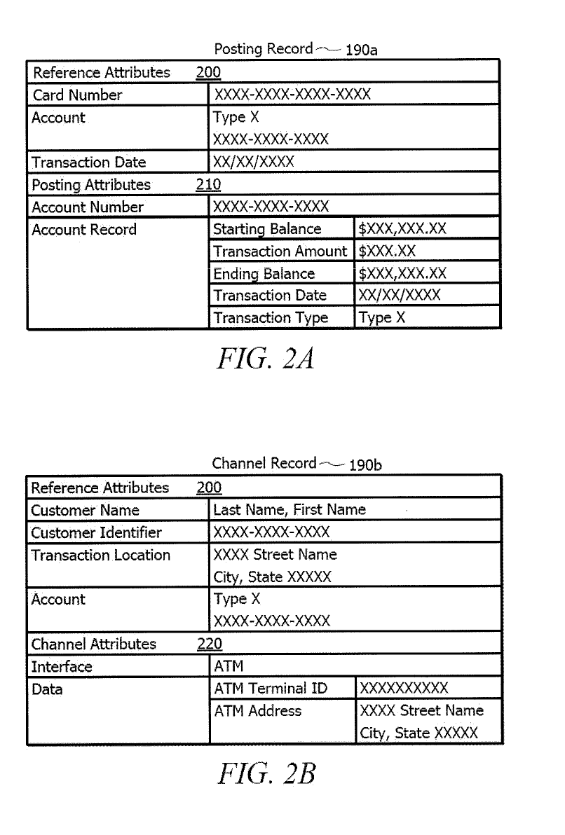

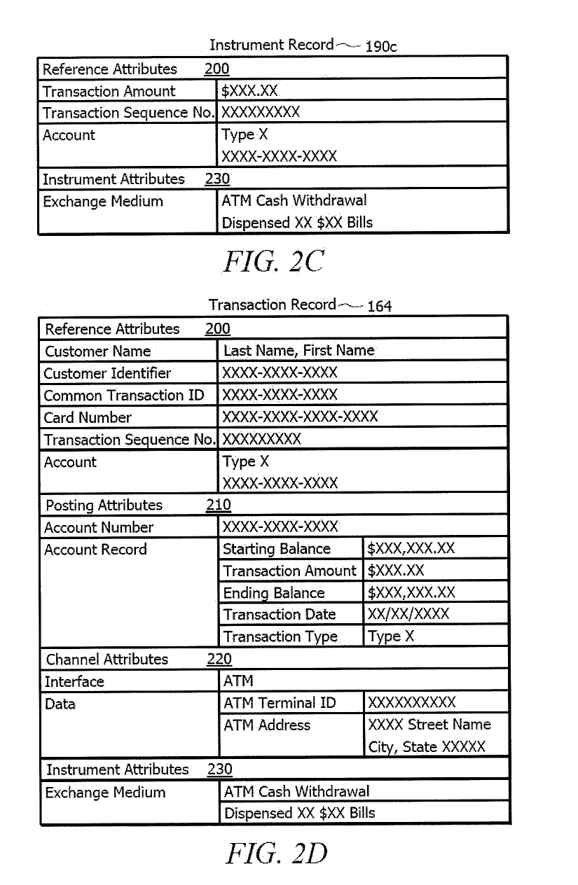

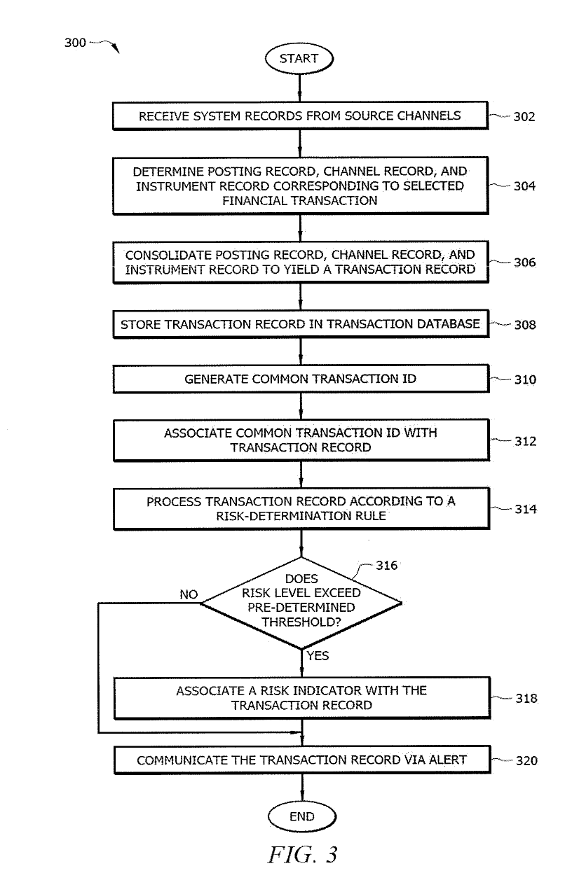

FIG. 2A illustrates an example of posting record 190a corresponding to a selected transaction of a plurality of financial transactions received from a first source 105a. Posting record 190a may include one or more reference attributes 200 that can be used to link other system records 190 to each other and/or to the selected transaction. Examples of reference attributes 200 include card number, customer name, customer identifier, transaction type, date, account number, account type, product, location, transaction amount, transaction sequence number, and so on. Posting record 190a may also include one or more posting attributes 210 that indicate a change in an account balance resulting from the selected transaction. Examples of posting attributes 210 include (but are not limited to) an account starting balance, account ending balance, account record, account number, and/or date of transaction.

In some embodiments, posting record 190a may be received from first source 105a in any suitable format. For example, posting record 190a can have a standardized format comprising standardized fields. In certain embodiments, posting record 190a can have a format that allows reference attributes 200 and posting attributes 210 to be presented to a user 135 or administrator 150 in the form of a table of rows and columns.

FIG. 2B illustrates an example of channel record 190b corresponding to a selected transaction of a plurality of financial transactions received from a second source 105b. Channel record 190b may include one or more reference attributes 200 that can be used to link other system records 190 to each other and/or to the selected transaction. Examples of reference attributes 200 include card number, customer name, customer identifier, transaction type, date, account number, account type, product, location, transaction amount, transaction sequence number, and so on. Channel record 190a may also include one or more channel attributes 220 that indicate how a customer interfaced with the financial institution to perform the selected transaction. Examples of channel attributes 220 include (but are not limited to) data describing an ATM, banking center, wire transfer portal, or online banking application that the customer interfaced with to perform the selected transaction.

In some embodiments, channel attributes 220 may include a channel type, address (e.g., street address or IP address), channel ID (ID identifying a terminal, banking center, online application, employee, etc.), date, and so on. As another example, channel attributes 220 may also indicate whether the customer interfaced with the channel directly (e.g., the customer can enter information into an ATM) or indirectly (e.g., the customer can request a bank employee to initiate a wire transfer on the customer's behalf).

In some embodiments, channel record 190b may be received from any one or more of a plurality of sources 105 (e.g., first source 105a, second source 105b, and/or third source 105c) in any suitable format. Thus, both posting record 190a and channel record 190b may be received from first source 105a, and/or both channel record 190b and instrument record 190c may be received from third source 105c, and/or channel record 190b may be received from second source 105b. Channel record 190b can have a standardized format comprising standardized fields. In certain embodiments, channel record 190b can have a format that allows reference attributes 200 and channel attributes 220 to be presented to a user 135 or administrator 150 in the form of a table of rows and columns.

FIG. 2C illustrates an example of instrument record 190c corresponding to a selected transaction of a plurality of financial transactions received from a third source 105c. Instrument record 190c may include one or more reference attributes 200 that can be used to link other system records 190 to each other and/or to the selected transaction. Examples of reference attributes 200 include card number, customer name, customer identifier, transaction type, date, account number, account type, product, location, transaction amount, transaction sequence number, and so on. Instrument record 190c may also include one or more instrument attributes 230 that indicate an exchange medium used in the selected transaction. Examples of the exchange medium that may be indicated by the one or more instrument attributes 230 may include (but are not limited to) a wire, cash check, account transfer, ATM deposit, or ATM withdrawal.

In some embodiments, instrument record 190c may be received from any one or more of a plurality of sources 105 (e.g., first source 105a, second source 105b, and/or third source 105c) in any suitable format. Thus, both posting record 190a and instrument record 190c may be received from first source 105a, and/or both channel record 190b and instrument record 190c may be received from second source 105b, and/or instrument record 190c may be received from third source 105c. Instrument record 190c can have a standardized format comprising standardized fields. In certain embodiments, instrument record 190c can have a format that allows reference attributes 200 and instrument attributes 230 to be presented to a user 135 or administrator 150 in the form of a table of rows and columns.

FIG. 2D illustrates an example of transaction record 164 that may be stored in a database of server memory 160. The database may comprise multiple transaction records 164, such as one or more of transaction records 164a to 164n of network storage device 125. Server memory 160 may store transaction records 164 in any suitable format.

Transaction record 164 may refer to a centralized view of a spectrum of system records 190 (e.g., posting record 190a, channel record 190b, and/or instrument record 190c) that correspond to the selected transaction. For example, transaction record 164 can include data that identifies the selected transaction, such as a unique transaction identifier (e.g., common transaction ID) or a combination of reference attributes 200 unique to the selected transaction (e.g., an account number in combination with a transaction sequence number and date, or any other suitable combination of reference attributes). It should be noted that reference attributes 200 in FIGS. 2A-2C can overlap (some are the same, some are different). Thus, transaction record 164 may include one or more reference attributes from posting record 190a, channel record 190b, and/or instrument record 190c, such as card number, customer name, customer identifier, transaction type, date, account number, account type, product, location, transaction amount, and/or transaction sequence number.

As another example, transaction record 164 can include one or more posting attributes 210 indicating a change in account balance resulting from the selected transaction (e.g., an account starting balance, account ending balance, account record, account number, and/or date of transaction), channel attributes 220 indicating how a customer interfaced with a financial institution to perform the selected transaction (e.g., data describing an ATM, banking center, wire transfer portal, or online banking application that the customer interfaced with to perform the selected transaction), and/or instrument attributes 230 indicating an exchange medium used in the selected transaction (e.g., cash, wire, check, account transfer, ATM deposit, or ATM withdrawal). In some embodiments, transaction record 164 can also include data associated with the account and/or customer that transacted the selected transaction, such as whether the account corresponds to a personal account or business account, contact information (e.g., email address, phone number, street address), related account information (e.g., other accounts owned by the same customer or members of the customer's household), risk status (e.g., whether the customer has recently conducted any potentially suspicious transactions), and/or other data.

In some embodiments, the database stores transaction record 164 in a format that allows the data to be presented to a user 135 or administrator 150 in the form of a table of rows and columns. For example, the rows of transaction record 164 may be organized according to reference attributes, posting attributes, channel attributes, and instrument attributes, and the columns may be organized according to descriptors describing the data. In some embodiments, the database presents a high-level view with hyperlinks to allow for drilling down into the details of a particular transaction or other information source.

FIG. 3 illustrates a method flowchart 300 for consolidating and communicating system records 190 corresponding to the selected transaction. The method begins at step 302 by receiving a plurality of system records 190 corresponding to a plurality of financial transactions from sources 105. System records 190 may include a plurality of posting records 190a received from a first source 105a, a plurality of channel records 190b received from a second source 105b, and a plurality of instrument records 190c received from a third source 105c. In some embodiments, one or more channel records 190b and/or one or more instrument records 190c may be received from any one or more of a plurality of sources 105. For example, both channel record 190b and instrument record 190c may be received from first source 105a, second source 105b, and/or third source 105c.

At step 304, the method may determine a subset of system records 190 that correspond to a selected one of the transactions, such as transaction number 1. As an example, the method may determine that posting record 190a(1), channel record 190b(1), and instrument record 190c(1) correspond to the selected transaction and therefore belong in the subset. In some embodiments, the method may determine that the subset of system records 190 correspond to the selected transaction by matching one or more reference attributes of posting record 190a(1), channel record 190b(1), and/or instrument record 190c(1). Examples of reference attributes that can be used to link the records to each other and/or to the selected transaction include card number, customer name, customer identifier, transaction type, date, account number, account type, product, location, transaction amount, transaction sequence number, and so on.

After determining that posting record 190a(1), channel record 190b(1), and instrument record 190c(1) correspond to the selected transaction, the method may consolidate and link one or more attributes of these records to yield transaction record 164 at step 306. Examples of attributes include reference attributes, posting attributes that indicate a change in an account balance resulting from the selected transaction (e.g., an account starting balance, account ending balance, account record, account number, and/or date of transaction), channel attributes that indicate how a customer interfaced with the financial institution to perform the selected transaction (e.g., data describing an ATM, banking center, wire transfer portal, or online banking application that the customer interfaced with to perform the selected transaction), and instrument attributes that indicate an exchange medium used in the selected transaction (e.g., cash, wire, check, account transfer, ATM deposit, or ATM withdrawal). Consolidating attributes can include adding attributes to transaction record 164, removing duplicate attributes included in transaction record 164, and/or reconciling inconsistencies in transaction record 164 (e.g., if different sources list attributes in different formats, consolidate the attribute that fits a target format). At step 308, the method may then store transaction record 164 in a transaction database of server memory 160.

At step 310, the method may generate a unique transaction identifier. The method may then associate the transaction identifier with transaction record 164 at step 312. The transaction identifier may refer to a unique identifier assigned by the financial institution to identify system records 190 that correspond to the selected transaction. For example, the transaction identifier may be used to identify the posting record 190a, channel record 190b, and instrument record 190c associated with the selected transaction and consolidated into transaction record 164.

In some embodiments, the method may process transaction record 164 according to a risk-determination rule to determine a risk level at step 314. An example of a risk-determination rule may be to determine whether transaction record 164 indicates that the selected transaction is associated with potentially suspicious activity. Examples of potentially suspicious activity may include cash structuring, large cash deposits, high-amount transactions or fund transfers inconsistent with the customer's transaction history or income, multiple wires to multiple people on the same day with corresponding dollar amounts, and so on. Then at step 316, the method determines if the risk level exceeds a pre-determined threshold. Upon a determination that the risk level does not exceed the pre-determined threshold, the method skips to step 320. Alternatively, if the risk level does exceed the pre-determined threshold, the method may associate a risk indicator with transaction record 164 at step 318. Any suitable risk indicator may be used.

At step 320, the method communicates transaction record 164. In some embodiments, transaction record 164 may be communicated via alert 195. Alert 195 may comprise one or more transaction records 164 associated with the customer and/or one or more risk indicators (e.g., based on suspicious activity, financial crimes, corruption, and/or economic sanctions compliance information) associated with one or more transaction records 164. Alert 195 may be communicated in any suitable format, including communicating alert 195 in a standardized format comprised of standardized fields. Moreover, alert 195 may be communicated to a display or other user interface, or it may be communicated to a downstream processor.

In some embodiments, in response to associating a risk indicator with transaction record 164 at step 318, the method may communicate the risk indicator associated with transaction record 164 to user 135. The method may communicate any suitable risk indicator. For example, the data that caused the risk to be generated may be highlighted in transaction record 164 or a text description of the risk may be provided in transaction record 164. In some embodiments, the method may communicate a risk score, such as a scored based on a formula that includes transaction record 164 as an input, that may be used by user 135 to evaluate the risk. The score may be calculated at a line of business level, an enterprise level, and/or other suitable level.

Once the method communicates alert 195 at step 320, the method ends.

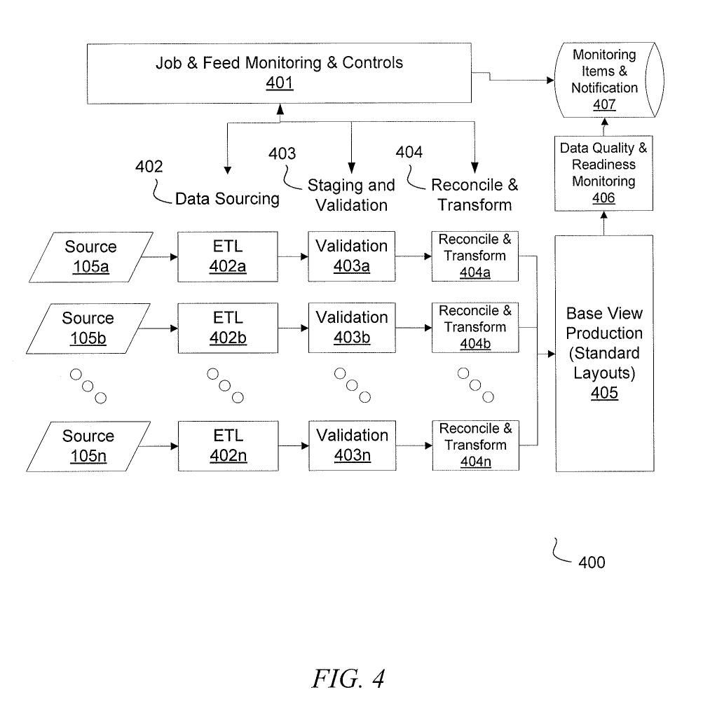

FIG. 4 illustrates a block diagram of an example system that consolidates and links customer transaction data from multiple sources 105a-105n into transaction records 164. Customer transaction data received from sources 105a-105n may include posting records 190a, channel records 190b, and/or instrument records 190c. As illustrated in FIG. 4, the example system includes a job feed module 401, sourcing module 402, validation module 403, transformation module 404, production module 405, monitoring module 406, and notification module 407.

In general, job feed module 401 provides a control interface that may allow user 135 to submit requests and/or to configure rules for monitoring the customer transaction data. In some embodiments, user 135 may be a financial institution employee conducting an investigative analysis of one or more financial transactions. In some embodiments, user 135 may utilize job feed module 401 to request transaction records 164 associated with a particular customer, transaction records 164 associated with a particular time period, and/or transaction records 164 associated with potentially suspicious activity (e.g., based on monetary amount, location, transaction frequency, risk level, and/or other criteria). In some embodiments, job feed module 401 is communicatively coupled to sourcing module 402, validation module 403, transformation module 404, and notification module 407.

Sourcing module 402 may perform the process of extracting, transforming, and loading data from sources 105 into a database of server memory 160. In some embodiments, sourcing module 402 receives system records 190 that correspond to a selected transaction. Sourcing module 402 may then extract transaction data associated with the selected transaction from system records 190. An example of transaction data includes data that identifies the selected transaction, such as a unique transaction identifier or a combination of reference attributes unique to the selected transaction (e.g., an account number in combination with a transaction sequence number and date, or any other suitable combination of reference attributes). As another example, transaction data can include data indicating a change in account balance resulting from the selected transaction, how a customer interfaced with a financial institution to perform the selected transaction, and/or an exchange medium used in the selected transaction. In certain embodiments, transaction data can also include data associated with the account and/or customer that transacted the selected transaction.

In some embodiments, sourcing module 402 may transform the transaction data extracted from system records 190 into any suitable format, such as a format compatible with server memory 160. In some embodiments, sourcing module 402 transforms the transaction data according to a set of rules and/or instructions, or using lookup tables. Sourcing module 402 may then load and store the transaction data in a database of server memory 160.

In certain embodiments, validation module 403 may cleanse data associated with system records 190 for any data quality issues. For example, validation module 403 may determine whether a particular system record 190 comprises sufficient information to correlate the particular system record 190 to a financial transaction and/or other system record 190. Sufficient information may include one or more reference attributes unique to a particular transaction. Examples of reference attributes that can be used to correlate a system record 190 to a selected transaction and/or other system record 190 include a card number, account number, account type, product, location, transaction amount, and/or transaction sequence number. Validation module 403 may then use one or more reference attributes of the particular system record 190 to determine whether the particular system record 190 corresponds to the selected transaction.

In some embodiments, transformation module 404 may determine that two system records 190 correspond to the selected transaction by matching one or more reference attributes of a first system record 190 to one or more reference attributes of a second system record 190. As an example, if both first system record 190 and second system record 190 comprise the same transaction sequence number, transformation module 404 may connect first system record 190 and second system record 190 to the selected transaction using the matching sequence numbers. In response, transformation module 404 can consolidate and link these records to yield transaction record 164. Consolidating records can include adding one or more attributes of one or more system records 190 to transaction record 164, removing duplicate attributes included in transaction record 164, and/or reconciling inconsistencies in transaction record 164 (e.g., if different sources list attributes in different formats, consolidate the attribute that fits a target format). Additionally, linking records can include connecting records to each other and/or to the selected transaction. Thus, transaction record 164 may refer to a consolidated view of transaction data in a standard presentation layer. An advantage of this embodiment includes removing data redundancies and inconsistencies, and reducing the cost and complexity of monitoring customer transactions for potentially suspicious activities. After yielding transaction record 164, transaction record 164 may be stored in a transaction database of server memory 160.

Production module 405 formats transaction record 164 in any suitable format. For example, transaction record 164 may be formatted in a standardized format comprising standardized fields (e.g., a consistent cross-product data architecture). In some embodiments, production module 405 may format transaction record 164 as an alert 195. Alert 195 may comprise one or more transaction records 164 associated with a customer and/or one or more risk indicators (e.g., based on suspicious activity, financial crimes, corruption, and/or economic sanctions compliance information) associated with one or more transaction records 164. In some embodiments, production module 405 may communicate alert 195 to a downstream processor, such as monitoring module 406, for further monitoring and eventual presentation to user 135 if further investigation is warranted.

In some embodiments, monitoring module 406 determines whether transaction record 164 should be communicated to downstream processes for monitoring, marketing, or other similar purposes. Monitoring module 406 may determine to communicate transaction record 164 in response to pre-configured criteria. For example, if a risk indicator is associated with transaction record 164, pre-configured criteria may cause monitoring module 406 to determine a risk score for transaction record 164. A risk score may be based on a formula that includes transaction record 164 as an input. Monitoring module 406 and/or user 135 may then use the score to evaluate the risk. If the risk score exceeds a pre-determined risk threshold, transaction record 164 may be communicated to notification module 407 for downstream processing (e.g., investigative analysis of transaction record 164).

Modifications, additions, or omissions may be made to the systems described herein without departing from the scope of the invention. The components may be integrated or separated. Moreover, the operations may be performed by more, fewer, or other components. For example, although certain examples describe receiving a posting record from a first source, a channel record from a second source, and an instrument record from a third source, in alternative embodiments the same source can provide two of the records. As an example, the second source could provide both the channel record and the instrument record. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an interface operable to:
receive a plurality of system records, each system record corresponding to one of a plurality of financial transactions;
one or more processors operable to:
determine a subset of system records that correspond to a selected transaction of the plurality of financial transactions, the subset of system records comprising a posting record, a channel record, and an instrument record for the selected transaction;
consolidate and link the posting record, the channel record, and the instrument record that correspond to the selected transaction to yield a transaction record; and
store the transaction record in a transaction database;
wherein:
the posting record comprises one or more posting attributes that a first source associates with the selected transaction, the one or more posting attributes indicating a change in an account balance resulting from the selected transaction;
the channel record comprises one or more channel attributes that a second source associates with the selected transaction, the one or more channel attributes indicating how a customer interfaced with a financial institution to perform the selected transaction; and
the instrument record comprises one or more instrument attributes indicating an exchange medium used in the selected transaction; and
the interface further operable to:
communicate the transaction record.

2. The system of claim 1, the one or more processors further operable to:
generate a unique transaction identifier; and
associate the unique transaction identifier with the transaction record.

3. The system of claim 1, wherein the one or more posting attributes comprise at least one account record and one account number.

4. The system of claim 1, wherein the one or more channel attributes comprise data describing an ATM, a banking center, a wire transfer portal, or an online banking application that the customer interfaced with to perform the selected transaction.

5. The system of claim 1, wherein the exchange medium indicated by the one or more instrument attributes corresponds to a wire, cash, check, account transfer, or ATM deposit.

6. The system of claim 1, the one or more processors further operable to:
process the transaction record according to a risk-determination rule to determine a risk level;
determine whether the risk level exceeds a pre-determined threshold; and
associate a risk indicator with the transaction record if the risk level exceeds the pre-determined threshold.

7. The system of claim 1, wherein the channel record and the instrument record are received from a plurality of sources.

8. A method, comprising:
receiving a plurality of system records, each system record corresponding to one of a plurality of financial transactions;
determining, by one or more processors, a subset of system records that correspond to a selected transaction of the plurality of financial transactions, the subset of system records comprising a posting record, a channel record, and an instrument record for the selected transaction;
consolidating and linking the posting record, the channel record, and the instrument record that correspond to the selected transaction to yield a transaction record;
storing the transaction record in a transaction database; and
communicating the transaction record;
wherein:
the posting record comprises one or more posting attributes that a first source associates with the selected transaction, the one or more posting attributes indicating a change in an account balance resulting from the selected transaction;
the channel record comprises one or more channel attributes that a second source associates with the selected transaction, the one or more channel attributes indicating how a customer interfaced with a financial institution to perform the selected transaction; and
the instrument record comprises one or more instrument attributes indicating an exchange medium used in the selected transaction.

9. The method of claim 8, further comprising:
generating a unique transaction identifier; and
associating the unique transaction identifier with the transaction record.

10. The method of claim 8, wherein the one or more posting attributes comprise at least one account record and one account number.

11. The method of claim 8, wherein the one or more channel attributes comprise data describing an ATM, a banking center, a wire transfer portal, or an online banking application that the customer interfaced with to perform the selected transaction.

12. The method of claim 8, wherein the exchange medium indicated by the one or more instrument attributes corresponds to a wire, cash, check, account transfer, or ATM deposit.

13. The method of claim 8, further comprising:
processing the transaction record according to a risk-determination rule to determine a risk level;
determining whether the risk level exceeds a pre-determined threshold; and
associating a risk indicator with the transaction record if the risk level exceeds the pre-determined threshold.

14. The method of claim 8, wherein the channel record and the instrument record are received from a plurality of sources.

15. A non-transitory computer readable storage medium comprising logic, the logic, when executed by a processor, operable to:
receive a plurality of system records, each system record corresponding to one of a plurality of financial transactions;
determine a subset of system records that correspond to a selected transaction of the plurality of financial transactions, the subset of system records comprising a posting record, a channel record, and an instrument record for the selected transaction;
consolidate and link the posting record, the channel record, and the instrument record that correspond to the selected transaction to yield a transaction record;
store the transaction record in a transaction database; and
communicate the transaction record;
wherein:
the posting record comprises one or more posting attributes that a first source associates with the selected transaction, the one or more posting attributes indicating a change in an account balance resulting from the selected transaction;
the channel record comprises one or more channel attributes that a second source associates with the selected transaction, the one or more channel attributes indicating how a customer interfaced with a financial institution to perform the selected transaction; and
the instrument record comprises one or more instrument attributes indicating an exchange medium used in the selected transaction.

16. The logic of claim 15, further operable to:
generate a unique transaction identifier; and
associate the unique transaction identifier with the transaction record.

17. The logic of claim 15, wherein the one or more posting attributes comprise at least one account record and one account number.

18. The logic of claim 15, wherein the one or more channel attributes comprise data describing an ATM, a banking center, a wire transfer portal, or an online banking application that the customer interfaced with to perform the selected transaction.

19. The logic of claim 15, wherein the exchange medium indicated by the one or more instrument attributes corresponds to a wire, cash, check, account transfer, or ATM deposit.

20. The logic of claim 15, further operable to:
process the transaction record according to a risk-determination rule to determine a risk level;
determine whether the risk level exceeds a pre-determined threshold; and
associated a risk indicator with the transaction record if the risk level exceeds the pre-determined threshold.
